(19) United States
(12) Patent Application Publication
(10) Pub. No.: US 2007/0058333 A1
(43) Pub. Date: Mar. 15, 2007

(54) COMPUTER HAVING A SUPPORTING PART TO SUPPORT A PERIPHERAL PART

(76) Inventor: Chil-sung KIM, Suwon-si (KR)

Correspondence Address: STANZIONE & KIM, LLP, 919 18TH STREET, N.W., SUITE 440, WASHINGTON, DC, 20006, US

(21) Appl. No.: 11/467,592

(22) Filed: Aug. 28, 2006

(30) Foreign Application Priority Data
Sep. 12, 2005 (KR) 2005-84776

(51) Int. Cl. G06F 1/16

(52) U.S. Cl. 361/683; 361/724

(57) ABSTRACT

A computer includes a main body casing which has a mounting opening, a peripheral unit which is mounted to the mounting opening, a supporter which supports the peripheral unit, a hinge which comprises a rotating shaft provided in one of the main body casing and the supporter to make the supporter rotate between a mounting position and an opening position of the main body casing, a shaft to support the other one of the main body casing and the supporter to be engaged with the rotating shaft, and a shaft guiding part which is extended from the shaft supporting hole and guides the rotating shaft to move the supporter from the opening position. The support of the computer is prevented from being rotated in an opening position and is detached from the computer without difficulty.

### CROSS-REFERENCE TO RELATED APPLICATIONS

This application claims priority under 35 U.S.C. §119(a) from Korean Patent Application No. 2005-0084776, filed on Sep. 12, 2005, in the Korean Intellectual Property Office, the disclosure of which is incorporated herein by reference.

### BACKGROUND OF THE INVENTION

1. Field of the Invention

The present general inventive concept relates to a computer, and more particularly, to a computer having a supporting part which is prevented from being rotated in an opening position and is detached from the computer without difficulty.

2. Description of the Related Art

Generally, a computer comprises peripheral units such as an optical disk drive (ODD), a floppy disk drive, card record medium and record generating apparatus, and a tape record medium memory.

The peripheral units are slidably inserted into a main body casing. Recently, the peripheral units have become rotatable to the main body casing, thereby repairing and replacing components for better performance without difficulty.

Japanese Patent First Publication No. 2002-236526 published on Aug. 23, 2002 discloses a hinge type mount for a storage drive in which a peripheral unit is rotatably coupled with a main body casing. In a conventional computer, a drive mounting part is provided in a rear surface of the storage drive for a quick and easy access. The conventional computer comprises a chassis, a bracket to mount at least one memory therein, and a hinge to enable the bracket to rotate between an opening position and a mounting position. The conventional computer further comprises a locking part to lock the bracket in the mounting position. With this configuration, a peripheral unit is mounted to the bracket to rotate with respect to the chassis, thereby replacing drives without difficulty, providing an easy access to the rear surface and ensuring a user's convenience.

In the conventional computer, as the bracket mounting the drive therein is rotated from the mounting position to the opening position, the bracket may be distorted or fall down due to an external force or shock while being repaired. Further, since the locking part is provided in only one lateral side of the bracket, the bracket is not uniformly pressed by a locking force, thereby causing inconvenience and deforming the bracket.

### SUMMARY OF THE INVENTION

Accordingly, it is an aspect of the present general inventive concept to provide a computer having a supporting part which is prevented from being rotated in an opening position and is detached from the computer without difficulty.

Additional aspects and/or advantages of the present general inventive concept will be set forth in part in the description which follows and in part, will be obvious from the description, or may be learned by practice of the present general inventive concept.

The foregoing and/or other aspects of the present general inventive concept may be achieved by providing a computer comprising a main body casing which has a mounting opening, a peripheral unit which is mounted to the mounting opening, a supporter which supports the peripheral unit, a hinge which comprises a rotating shaft provided in one of the main body casing and the supporter to control the supporter to rotate between a locking position and an opening position of the main body casing and a shaft to support the other one of the main body casing and the supporter to be engaged with the rotating shaft, and a shaft guiding part which is extended from the shaft supporting hole and guides the rotating shaft to move the supporter from the opening position to a mounting position.

The rotating shaft may protrude from a plate surface of either the main body casing or the supporter, and comprises at least one rotation preventing surface formed on a part thereof as a non-circular shape.

The shaft guiding part may include a section which communicates with the shaft supporting hole and is smaller than that of the shaft supporting hole to guide the rotating shaft by being engaged with the rotation preventing surface of the rotating shaft.

The computer may further include a locking unit which locks the supporter to prevent from rotating from the locking position to the opening position.

The locking unit may include a locking bracket which is coupled with the main body casing and protrudes therefrom, at least one locking projection which protrudes from the plate surface of the supporter to the locking bracket, a locking part which comprises a locking projection accommodator engaged with the locking projection and is slidably provided along a plate surface of the locking bracket, and a releasing part which is rotated with respect to the plate surface of the main body casing and includes a first end thereof coupled with the locking part to be released by a predetermined pressure and a second end hingedly coupled with the main body casing.

The computer may further include an elastic member which is coupled with the locking bracket and elastically presses the locking part to lock the supporter in the locking position.

The elastic member may include a spring.

The locking part may include at least one sliding slot which is shaped like an elongated hole and provided along a sliding direction, and at least one sliding projection which is coupled with the locking bracket and engaged with the sliding slot to guide the locking part.

The peripheral unit may include an optical disk drive (ODD).

The foregoing and/or other aspects of the present general inventive concept may also be achieved by providing a computer having a main body casing and a peripheral unit to be mounted to the main body casing, the computer including a supporter mounted with a peripheral unit and rotatably connected to the main body casing to move between a locking position where the supporter is locked to the main body casing and an opening position where the supporter rotates with respect to the main body casing, and a shaft guiding part to guide the supporter to move the opening position to a mounting position where the peripheral unit is inserted into or detached from the supporter.

The foregoing and/or other aspects of the present general inventive concept may also be achieved by providing a computer having a main body casing and a peripheral unit to be mounted to the main body casing, the computer including a supporter mounted with a peripheral unit and rotatably mounted to the main body casing to move to one of a locking position where the supporter is locked to the main body casing, an opening position where the supporter rotates with respect to the main body casing, and a mounting position where the supporter is prevented from rotating; a locking unit to lock the support in the locking position and to release the support from the locking position to the opening position, a hinge to control the support to move from the opening position to the locking position, and a rotation prevention unit to control the support to move from the opening position to the mounting position.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a peripheral unit which is mounted to a main body casing of a computer according to an embodiment of the present general inventive concept;

FIG. 2 is an exploded perspective view illustrating the peripheral unit of the computer of FIG. 1;

FIG. 3 is a partial enlarged view illustrating a locking unit of the computer of FIGS. 1 and 2;

FIG. 4 is an enlarged sectional view illustrating a hinge and a shaft guiding part of the computer of FIGS. 1 and 2; and

FIGS. 5A, 5B, and 5C are views illustrating a rotation of the peripheral unit and an operation of a rotating shaft of the peripheral unit of the computer of FIGS. 1 and 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

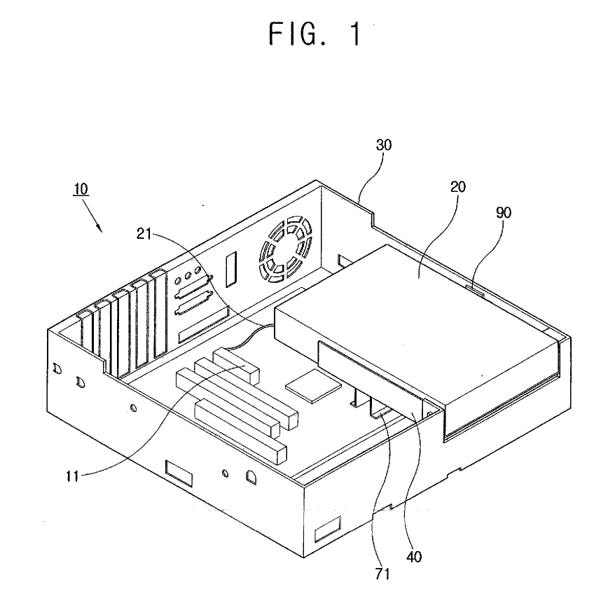

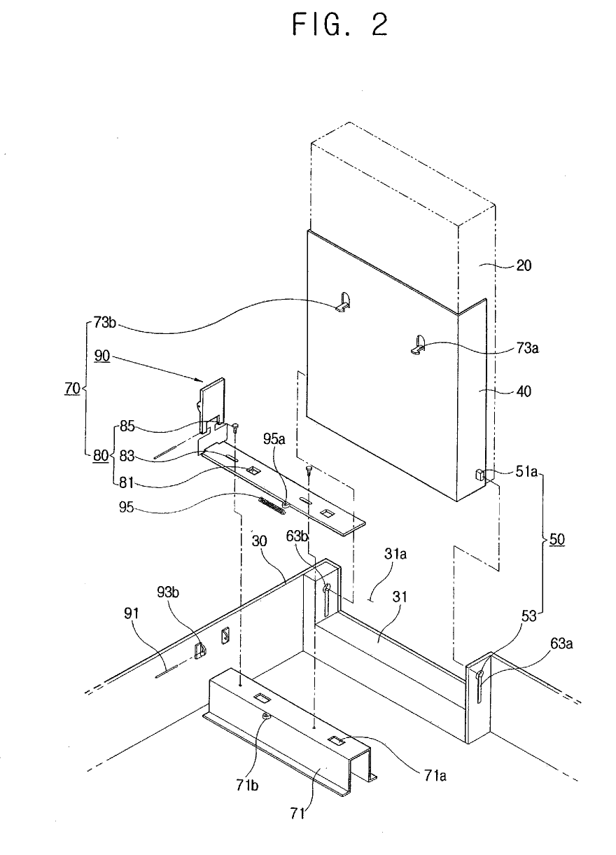

As illustrated in FIGS. 1 and 2, a computer 10 according to an embodiment of the present general inventive concept may include a main body casing 30 which has a mounting opening 31a, a peripheral unit 20 which is mounted to the main body casing 30 through the mounting opening to be connected to an electrical component 11 of the computer 10 using a cable 21, a supporter 40 which supports the peripheral unit 20, a rotating shaft 51 which is provided in one of the main body casing 30 and the supporter 40 such that the supporter 40 rotates between a locking position, an opening position, and a mounting position with respect to the main body casing 30, a hinge 50 which has a shaft supporting hole 53 provided in the other one of the main body casing 30 and the supporter 40 to be engaged with the rotating shaft 51, and a shaft guiding part 63 which is extended from the shaft supporting hole 53 and guides the rotating shaft 51 to move the supporter 40 from the opening position to the mounting position. The computer 10 may further include a locking unit 70 which locks the supporter 40 not to rotate from the locking position to the opening position. The locking unit 70 includes a releasing part 90, a locking part 80 connected to the releasing part 90 to lock and release the supporter 40, and a locking bracket 71 mounted on a bottom of the main body casing 30

The peripheral unit 20 comprises one or more various record media generating and storing apparatuses such as an optical disk drive (ODD), a floppy disk drive, a card type record media generating apparatus and a tape type record media memory. The peripheral unit 20 is coupled with the supporter 40, and rotates between the mounting position and the opening position and between the opening position and the locking position with respect to the main body casing 30 by the hinge 50. The peripheral unit 20 is rotatable to be replaced for better performance without difficulty.

As illustrated in FIGS. 1 through 4, the main body casing 30 comprises the mounting opening 31a to accommodate the peripheral unit 20. The main body casing 30 is coupled with the supporter 40 using a rotation prevention unit 60 including a rotation preventing surface 61 and a shaft guiding part 63, the hinge 50 including a shaft supporting hole 53 and a rotating shaft 51, the releasing part 90, and the locking bracket 71. The main body casing 30 is provided as a plate to be coupled with various electronic components. The main body casing 30 comprises a material such as metal or plastic.

The supporter 40 is provided as a plate, each lateral side of which is bent from a plate surface as a U-shape to support the peripheral unit 20. A locking projection 73 (73a and 73b) protrudes from the plate surface of the supporter 40 to the locking bracket 71 to be engaged with a locking projection hole 81 formed on the locking part 80. The supporter 40 is coupled with the hinge 50 to rotate with respect to the main body casing 30.

The supporter 40 is coupled to the main body casing 30 using the hinge 50 to control the supporter 40 supporting the peripheral unit 20 to rotate between the mounting position and the opening position and between the opening position and the locking position with respect to the main body casing 30. The hinge 50 comprises the rotating shaft 51, which protrudes from the lateral side of the plate surface of the supporter 40, and the shaft supporting hole 53 which is provided on the main body casing 30 to be engaged with the rotating shaft 51. The hinge 50 may comprise an elastic member such as a spring to elastically press the supporter 40 from the locking position to the opening position. Alternatively, the rotating shaft 51 may be provided in the main body casing 30, and the shaft supporting hole 53 may be formed on the supporter 40.

The rotation preventing unit (61 and 63) includes the shaft guiding part 63 which is formed on a side plate of the main body casing 30 to guide the rotating shaft 51 to make the supporter 40 contact a mounting opening circumferential part 31 of the main body casing 30 in the opening position, and the rotation preventing surface 61 which is provided on the rotating shaft 51 as a non-circular shape, to prevent a rotation of the supporter 40 by being engaged with the shaft guiding part 63. When the supporter 40 is moved from the opening position to the mounting position, the supporter 40 is prevented from being rotated, thereby detaching the peripheral unit 20 from the computer 10 without difficulty and preventing a free fall due to an external force or an unbalance.

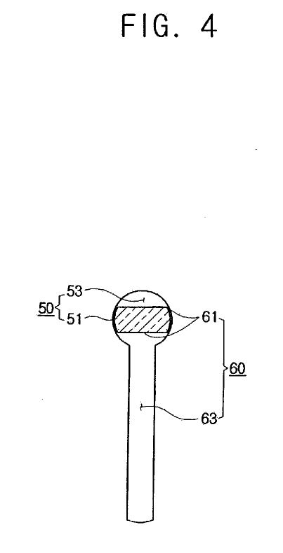

As illustrated in FIGS. 2 and 4, the rotation preventing surface 61 is formed on the rotating shaft 51 protruding from the plate surface of the supporter 40, as a non-circular shape to guide an operation of the supporter 40 and prevents the supporter 40 from being rotated. The rotation preventing surface 61 is formed on opposite lateral sides of the rotating shaft 51, but not limited thereto. Alternatively, the rotation preventing surface 61 may be formed only one lateral side of the rotating shaft 51.

The shaft guiding part 63 is shaped like an elongated hole which penetrates the plate surface of the main body casing 30 to slidably guide the rotating shaft 51 by being engaged with the rotation preventing surface 61. Alternatively, the shaft guiding part 63 may be depressed on the plate surface of the main body casing 30 to correspond to the rotation preventing surface 61 of the rotating shaft 51. The shaft guiding part 63 communicates with the shaft supporting hole 53 and has a smaller section than the shaft supporting hole 53 to be engaged with the rotation preventing surface 61. Alternatively, the shaft guiding part 63 may be provided in the supporter 40, and the rotation prevention surface may be formed on the plate surface of the main body casing 30.

Then, the rotating shaft 51 is accommodated to the shaft supporting hole 53, thereby rotating the supporter 40 between the locking position and the opening position. The rotating shaft 51 moves along the shaft guiding part 63 by the rotation preventing surface 61, thereby being prevented from being rotated.

That is, the supporter 40 moves between the opening position where the rotating shaft 51 is disposed in the shaft supporting hole 53 of the hinge 50 such that the supporter 40 can be rotatable with respect to the main body casing 30, the mounting position where the rotation prevention surface 61 of the rotating shaft 51 is disposed in the shaft guide part 63 such that the supporter 40 is prevented from being rotated with respect to the main body casing 30 and the peripheral unit 20 can be inserted into or removed from the supporter 40 in a stable state, and a locking position where the supporter 40 rotates from the opening position to be locked to the locking bracket 71.

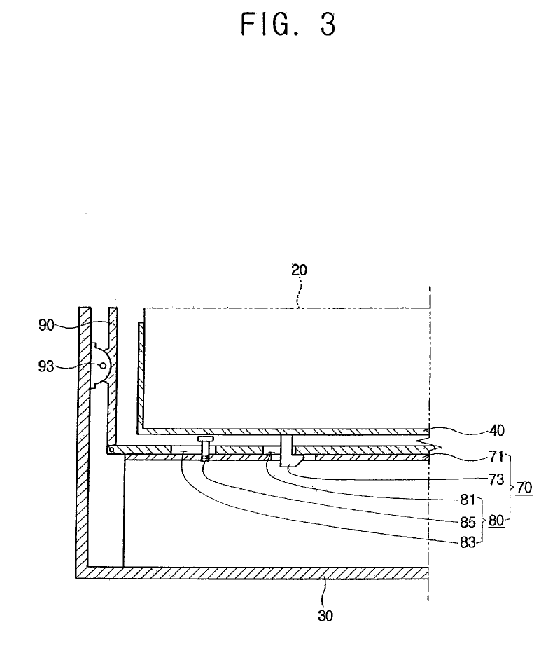

As illustrated in FIGS. 2 and 3, the locking unit 70 comprises the locking bracket 71 which is coupled with the main body casing 30 and protrudes therefrom, at least one locking projection 73 (73a and 73b) which protrudes from the plate surface of the supporter 40 to the locking bracket 71, the locking part 80 which has the locking projection hole 81 being engaged with the locking projection 73 and slidably provided along a plate surface of the locking bracket 71, and the releasing part 90 having a first side coupled with the locking part 80 to be released by a predetermined pressure and a second side hingedly coupled with the main body casing 30 to rotate with respect to the plate surface of the main body casing 30.

The locking part 80 is provided on an upper part of the locking bracket 71 which is coupled with the main body casing 30 and protrudes from the main body casing 30. The locking bracket 71 comprises a material such as metal, plastic, etc. and is shaped like a plate. The locking bracket 71 is coupled with a sliding projection 85 through a sliding slot 83 (to be described later). The locking bracket 71 may vary in a protruding height from the bottom of the plate surface of the main body casing 30 corresponding to a size of the peripheral unit 20.

The locking projection 73 is engaged with the locking bracket 71 through the locking projection hole 81 and a second projection hole 71a and protrudes downwards from the plate surface of the supporter 40 to make the supporter 40 remain locked in the locking position. The locking projection 73 is shaped like a hook. The locking projection 73 is chamfered along an insertion direction to be easily inserted into the locking projection hole 81. If there is provided one locking projection 73, the locking projection 73 may be provided on a center of the plate surface of the supporter 40 to supply a locking force uniformly.

The locking part 80 comprises the locking projection hole 81 to be engaged with the locking projection 73. The locking part 80 is coupled with the locking bracket 71 and the releasing part 90 to slide along a plate surface of the locking bracket 71 where the second projection hole 71a is formed. The locking part 80 comprises at least one sliding slot 83 which is shaped like an elongated hole and is provided along a sliding direction of the locking bracket 71, and at least one sliding projection 85 which is coupled with the locking bracket 71 to be engaged with the sliding slot 83 and to slidably guide the locking part 80.

The sliding slot 83 is formed like an elongated hole to slide along the plate surface of the locking bracket 71 by being engaged with the sliding projection 85. The sliding slot 83 may be provided in plural to make the locking part 80 slide stably.

The sliding projection 85 is coupled with the locking bracket 71 to move along the sliding slot 83 to allow the locking part 80 to slide along the locking bracket 71 by being engaged with the sliding slot 83. The sliding projection 85 may be provided in plural to make the locking part 80 slide stably. The sliding projection 85 is shaped like a screw, but not limited thereto. Alternatively, the sliding projection 85 may be shaped like a pin to be coupled to the locking part 80 and the licking bracket 71 through the sliding slot 83 where the locking part 80 slidably moves with respect to the locking bracket 71.

The releasing part 90 includes a first side coupled with the locking part 80, and a second side hingedly coupled with the main body casing 30 to be rotated with respect to the main body casing 30 by being pressed by a user. As the releasing part 90 rotates, the locking part 80 coupled with the releasing part 90 slides along a direction in which the locking projection 73 is detached from the locking projection hole 81, thereby releasing the supporter 40 from the locking bracket 71. The releasing part 90 comprises a releasing rotation shaft 91 which rotates with respect to the plate surface of the main body casing 30; and a releasing rotation shaft hole 93 which is coupled with the releasing rotation shaft 91.

An elastic part (not shown) may be provided in the releasing part 90 as a spring, to elastically press the locking part 80 and to be coupled with the releasing rotation shaft 91 so that the supporter 40 remains locked.

The elastic member 95 is coupled to a protrusion 95a of the locking part 80 and another protrusion 71b of the locking bracket 71 to elastically press the locking part 80 and to lock the supporter 40 in the mounting position. The elastic member 95 may comprise a spring.

As the locking unit 70 is used to lock and release the supporter 40, a user may lock or unlock the supporter 40 without difficulty.

In the present embodiment, the computer is described as an example of the present general inventive concept, but not limited thereto. The present general inventive concept is applicable to other electronic apparatuses having a peripheral unit rotatably mounted therein.

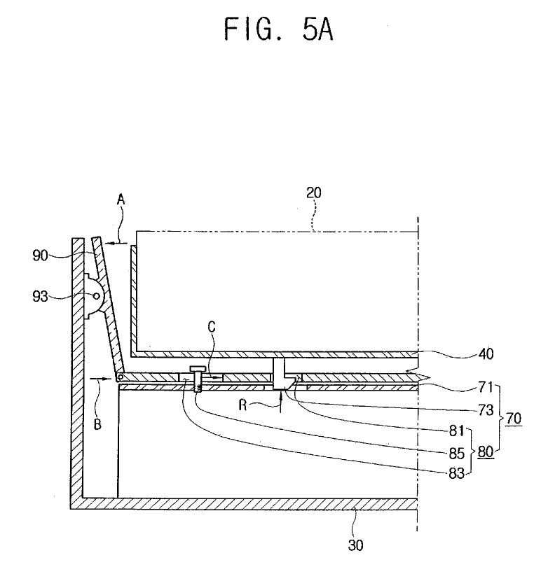

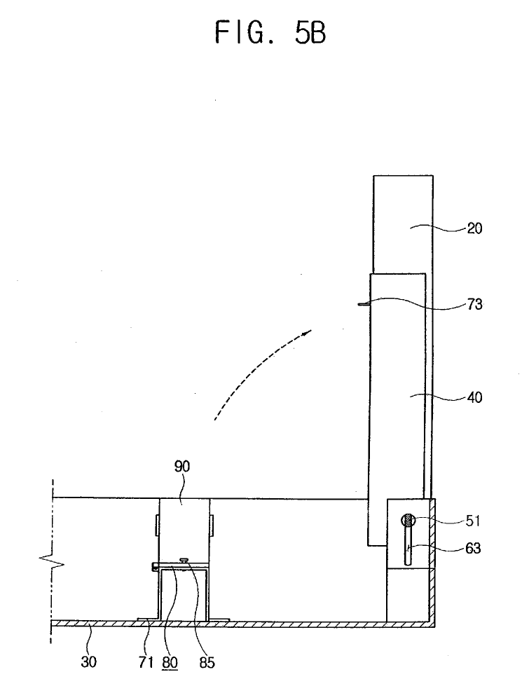

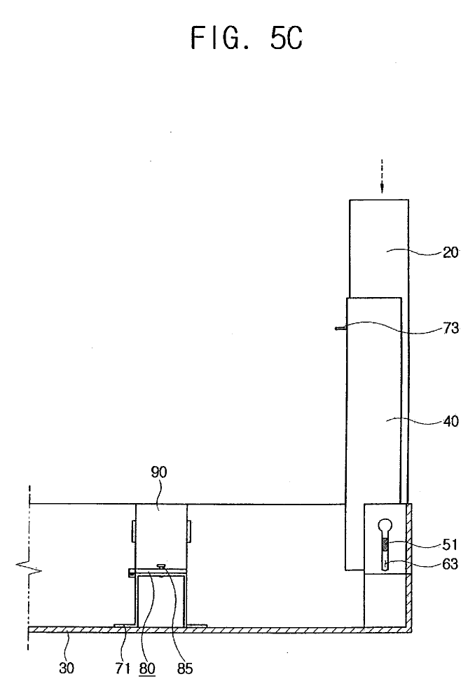

With this configuration, a process of operating the computer 10 according to the present general inventive concept will be described with reference to FIGS. 5A through 5C.

First, a process of releasing the supporter 40 from the computer 10 will be described. As illustrated in FIGS. 5A and 5B, a first end of the releasing part 90 is pressed toward the main body casing 30 in an arrow (A) direction. As the releasing part 90 is rotated to the main body casing 30 in an arrow (B) direction, a second end of the releasing part 90 moves in the arrow (B) direction to be spaced from a side plate surface of the main body casing 30. The locking part 80 coupled with the second end of the releasing part 90 slides along an arrow (C) direction in which the locking projection 73 is released from the locking position in an arrow (R) direction. The locking projection 73 is separated from the locking projection hole 81 such that the supporter 40 can rotate from the locking position to the opening position as illustrated in FIG. 5B. The hinge 50 may include an elastic part, such as a spring, so that the supporter 40 can be rotated from the locking position to the opening position by a predetermined elastic force without difficulty. Then, the peripheral unit 20 is in a state to be released from the supporter 40 and/or the computer 10. Also, the locking unit 70 may be provided in plural so as to perform a lock and/or unlock operation stably.

Hereinafter, a process of preventing a rotation of the supporter 40 will be described. As illustrate in FIG. 5C, the rotation preventing surface 61 of the rotating shaft 51 is positioned to be guided by the shaft guiding part 63 in the opening position of the supporter 40. The shaft guiding part 63 guides the rotation preventing surface 61 and moves the supporter 40 to be contacted with the mounting opening circumferential part 31 of the main body casing 30. The rotation preventing surface 61 is accommodated to the shaft guiding part 63. The first end of the supporter 40 is contacted with the mounting opening circumferential part 31 to prevent the supporter 40 from being rotated. Accordingly, the supporter 40 can be prevented from being distorted by the external force or shock, or falling down while being repaired, thereby protecting components and a user from a possible accident.

Hereinafter, a process of locking the supporter 40 will be described. A user moves the supporter 40 from the mounting position where the supporter 40 is contacted with the mounting opening circumferential part 31, to the opening position. A user presses the supporter 40 from the opening position to the locking position, to insert the locking projection 73 of the supporter 40 into the locking projection hole 81 of the locking part 80. The elastic member 95 elastically presses the locking part 80 to control the supporter 40 to remain locked in the locking position.

As described above, the supporter is rotated from the locking position to the opening position, and moved from the opening position to the mounting position to be prevented from being rotated. Accordingly, the supporter can be prevented from being distorted by the external force or the shock, or falling down. Also, electronic components which are adjacent to the peripheral unit or the supporter can be easily replaced or repaired. Further, products or users can be prevented from possible accidents. As the supporter is stably locked and unlocked, a deformation of the supporter can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A computer having a main body casing which has a mounting opening, and a peripheral unit which is mounted to the main body casing through the mounting opening, the computer comprising:
a supporter which supports the peripheral unit;
a hinge which comprises a rotating shaft provided in one of the main body casing and the supporter to control the supporter to rotate between a locking position and an opening position of the main body casing, and a shaft to support the other one of the main body casing and the supporter to be engaged with the rotating shaft; and
a shaft guiding part which is extended from the shaft supporting hole and guides the rotating shaft to move the supporter from the opening position to a mounting position.

2. The computer according to claim 1, wherein the rotating shaft protrudes from a plate surface of either the main body casing or the supporter, and comprises at least one rotation preventing surface formed on a part of the rotating shaft as a non-circular shape.

3. The computer according to claim 2, wherein the shaft guiding part comprises a section which is smaller than that of the shaft supporting hole and communicates with the shaft hole to guide the rotating shaft by being engaged with the rotation preventing surface of the rotating shaft.

4. The computer according to claim 1, further comprising:
a locking unit which locks the supporter to prevent from rotating from the locking position to the opening position.

5. The computer according to claim 4, wherein the locking unit comprises:
a locking bracket which is coupled with the main body casing and protrudes therefrom;
at least one locking projection which protrudes from the plate surface of the supporter to the locking bracket;
a locking part which comprises a locking projection accommodator engaged with the locking projection and is slidably provided along a plate surface of the locking bracket; and
a releasing part which is rotated with respect to the plate surface of the main body casing and includes a first end coupled with the locking part to be released by a predetermined pressure, and a second end hingedly coupled with the main body casing.

6. The computer according to claim 4, further comprising:
an elastic member which is coupled with the locking bracket and elastically presses the locking part to lock the supporter in the locking position.

7. The computer according to claim 6, wherein the elastic member comprises a spring.

8. The computer according to claim 5, wherein the locking part comprises at least one sliding slot which is shaped like an elongated hole and provided along a sliding direction of the locking bracket, and
at least one sliding projection which is coupled with the locking bracket and engaged with the sliding slot to guide the locking part.

9. The computer according to claim 1, wherein the peripheral unit comprises an optical disk drive (ODD).

10. A computer having a main body casing and a peripheral unit to be mounted to the main body casing, the computer comprising:
a supporter mounted with a peripheral unit and rotatably connected to the main body casing to move between a locking position where the supporter is locked to the main body casing and an opening position where the supporter rotates with respect to the main body casing; and
a shaft guiding part to guide the supporter to move the opening position to a mounting position where the peripheral unit is inserted into or detached from the supporter.

11. The computer according to claim 10, further comprising:
a hinge having a rotating shaft formed on one of the main body casing and the supporter, and a shaft supporting hole formed on the other one of the main body casing and the supporter to be engaged with the rotating shaft such that the supporter rotates between the locking position and the opening position.

12. The computer according to claim 10, further comprising:
a locking bracket formed on the main body casing; and
a locking projection formed on the supporter to receive the locking bracket when the supporter moves from the opening position to the locking position.

13. The computer according to claim 12, further comprising:
a locking part movably disposed between the locking bracket and the supporter to hold the locking projection in a locking state.

14. The computer according to claim 13, further comprising:
a releasing part rotatably coupled to the main body casing to control the locking part to slide with respect to the main body casing to release the locking projection in a release state from the locking state.

15. The computer according to claim 10, further comprising:
a rotating shaft formed on one of the main body casing and the supporter; and
a shaft supporting hole formed on the other one of the main body casing and the supporter to receive the rotating shaft,
wherein the shaft guiding part is extended from the shaft supporting hole to guide the rotation shaft from the opening position to the mounting position.

16. The computer according to claim 15, wherein the shaft guiding part comprises an elongated hole having a width narrower than a diameter of the shaft supporting hole.

17. The computer according to claim 16, wherein the rotating shaft comprises a rotating prevention portion formed thereon and having a thickness corresponding to the width of the elongated hole and a length corresponding to the diameter of the shaft supporting hole.

18. The computer according to claim 15, wherein the rotation shaft slides along the shaft guided part from the shaft supporting hole such that the supporter is prevented from rotating with respect to the main body casing.

19. The computer according to claim 15, wherein the rotation shaft rotates in the shaft supporting hole such that the supporter moves between the locking position and the opening position and slides in the shaft guiding part between the opening position and the mounting position.

20. A computer having a main body casing and a peripheral unit to be mounted to the main body casing, the computer comprising:
a supporter mounted with a peripheral unit and rotatably mounted to the main body casing to move to one of a locking position where the supporter is locked to the main body casing, an opening position where the supporter rotates with respect to the main body casing, and a mounting position where the supporter is prevented from rotating;
a locking unit to lock the support in the locking position and to release the support from the locking position to the opening position;
a hinge to control the support to move from the opening position to the locking position; and
a rotation prevention unit to control the support to move from the opening position to the mounting position.

21. The computer according to claim 20, wherein the supporter moves from the opening position to one of the locking position and the mounting position.

22. The computer according to claim 20, wherein the supporter rotates between the opening position and the locking position.

23. The computer according to claim 20, wherein the rotation prevention unit prevents the supporter from rotating with respect to the main body casing during moving between the opening position and the mounting position.
